(19) United States
(12) Patent Application Publication
(10) Pub. No.: US 2025/0155113 A1
(43) Pub. Date: May 15, 2025

(54) LIGHT POST BUTT-JOINT CONDUCTIVE COMPONENT STRUCTURE FOR DECORATIVE LIGHT

(71) Applicant: Xiaofeng ZHANG, Zhejiang (CN)

(72) Inventor: Xiaofeng ZHANG, Zhejiang (CN)

(21) Appl. No.: 18/912,510

(22) Filed: Oct. 10, 2024

(30) Foreign Application Priority Data
Nov. 13, 2023 (CN) 202323056933.6

(51) Int. Cl. F21V 23/06; F21V 17/12; F21V 17/16

(52) U.S. Cl. CPC F21V 23/06; F21V 17/12; F21V 17/168

(57) ABSTRACT

A light post butt-joint conductive component structure for a decorative light includes a light post including a light post body, at least one end in the light post body has a conductive component in a matched manner, the conductive component includes first and second components, the first component is formed with an accommodating cavity for butt joint of the second component, the accommodating cavity includes a cavity inlet and a cavity outlet, which is configured to correspondingly match with a butt-joint hole in the light post body. The second component is accommodated in the accommodating cavity. When the first component accommodating the second component is embedded and mounted in an inner cavity of the light post body, the second component extends outward from the cavity outlet, partially passes through the butt-joint hole to an outside of the light post body, and is limited and locked to the light post body.

### CROSS-REFERENCE TO RELATED APPLICATION

This application claims the priority benefit of China application serial no. 202323056933.6, filed on Nov. 13, 2023. The entirety of the above-mentioned patent application is hereby incorporated by reference herein and made a part of this specification.

### BACKGROUND

### Technical Field

The present invention relates to the technical field of outdoor decorative lights, particularly to a light post butt-joint conductive component structure for a decorative light.

### Description of Related Art

As a common holiday decoration, the tree light mainly includes a light post and several branch rods wound around the light post, and tree lights with different shapes are formed by winding LED string lights or inserting different LED decorative light bars.

Christmas tree lights are the most commonly used artificial tree decorations in Christmas celebrations. The artificial Christmas tree light is mainly composed of a base, a trunk column, branches, and colored lights, with a trunk standing on the base. For the convenience of storage and transportation, the trunk is generally formed by inserting two or more hollow tubes, each of which is provided with a branch with a colored light. To provide power for the colored light on the upper branch of a conventional Christmas tree, a plug and a socket in plug fit are disposed between the colored lights on the upper and lower branches. During assembly, the trunk column is inserted, and then the plug is manually inserted into the socket, which is inconvenient in operation, especially for a large Christmas tree. Due to the obstruction of the branches, the process of search and insertion is even more inconvenient.

In view of this, as stated in publication patent number CN206524506U, a combined power socket for an artificial Christmas tree is disclosed, including a first socket and a second socket that match with each other and are both in a ring structure capable of being sleeved on the outer surface of a rod-like or tube-like object, where the outer sidewalls of the two sockets or the parts thereof close to the outer sidewalls are formed with wire outlets. A first conductive connector is led out of the wire outlet of one of the two sockets through a conductive wire, and a second conductive connector adapted to the first conductive connector or a power plug adapted to an external power socket is led out of the wire outlet of the other through a conductive wire. At least one power supply connector is led out of the wire outlet of at least one of the two sockets through a conductive wire. The first socket and the second socket of the combined power socket according to the present invention are grouped in pairs, can be connected to each other, and are connected to other groups to achieve interconnection. Meanwhile, the power supply connector led out of each group of the combined power socket is used to provide power for external devices, such as string lights, thereby making it simpler for structure and more convenient for connection of the external devices.

As stated in publication patent number WO2023137722A1, a power connector for a Christmas tree is disclosed, including a male plug tube and a female plug tube, as well as a male plug and a female plug matching with each other, where the front end of a shaft shoulder of the male plug is formed with an inner cavity with a positioning function, a male plug terminal is inserted into the inner cavity with the positioning function, and the male plug is nested into the male plug tube through an anti-movement structure; the female plug has a cavity for insertion of the male plug, an inner boss is provided in the cavity and matches in size with the inner cavity with the positioning function on the male plug, a female plug terminal in butt joint with the male plug terminal is provided on the inner boss, and the female plug is nested into the female plug tube through an anti-movement structure; and the male plug tube serves to insert the nested male plug into the cavity of the female plug inside the female plug tube. According to the present invention, through a bidirectional insertion structure provided on the plug, fast connection of the power supply is achieved without wire alignment, there are high stability and reliability of connection and good performance in use, and it is ensured that the joint is not prone to radial movement or rotation; meanwhile, due to the use of the bidirectional insertion structure, the power connector has a certain waterproof effect, is simple in structure, low in production cost, easy to assemble and disassemble, not prone to falling off, and suitable to be widely applied to Christmas trees, and solves the technical problem of inconvenience in connection of colored lights on an existing Christmas tree.

In the above structure, for the butt joint of the trunk (the light post), the butt joint between upper and lower post bodies can be achieved through inner cavity type male and female plugs. However, an existing butt-joint mounting structure for the male and female plugs and the post bodies is relatively complex. In addition, when the light post is in conductive butt joint with other external branch rods, it is necessary to lead out wires from the insides of the post bodies and then conduct conductive butt joint. During assembly of the light post, wire routing is relatively troublesome for a user, affecting its assembly efficiency; meanwhile, the extension of wires easily leads to safety issues such as electric shock or fire caused by wear and electric leakage during long-term use.

### SUMMARY

In view of the above problems, the present invention aims to provide a light post butt-joint conductive component structure for a decorative light. A conductive component is of a split butt-joint structure and is conveniently assembled with a light post using a plug-in structure, thereby improving the convenience in mounting, and facilitating external conductive butt-joint.

The technical problems solved by the present invention can be addressed using the following technical solution:

A light post butt-joint conductive component structure for a decorative light, including a light post, the light post including at least one section of light post body, at least one end in the light post body being provided with a conductive component in a matched manner, where the conductive component includes a first component and a second component, the first component is formed with an accommodating cavity for butt joint of the second component, the accommodating cavity includes a cavity inlet and a cavity outlet, and the cavity outlet is configured to correspondingly match with a butt-joint hole in the light post body; and the second component is accommodated in the accommodating cavity, and when the first component accommodating the second component is embedded and mounted in an inner cavity of the light post body, the second component extends outward from the cavity outlet, partially passes through the butt-joint hole to an outside of the light post body, and is limited and locked to the light post body.

A locking fastener is further included, the second component includes a second component body and an extension component located at one end of the second component body, the second component body is embedded in the accommodating cavity, the extension component extends to an outer end of the butt-joint hole, and the locking fastener is configured to be in locking fit with the extension component.

The second component further includes a second embedded conductive terminal, a side of the extension component is formed with a second terminal jack, and the second embedded conductive terminal is embedded and mounted in the second component and correspondingly matches with the second terminal jack.

The first component further includes a first embedded conductive terminal, the first component is further formed with a first terminal jack, the first embedded conductive terminal is embedded and mounted in the first component and correspondingly matches with the first terminal jack, and the first embedded conductive terminal is conductively connected to the second embedded conductive terminal by a wire.

The locking fastener is either an external nut or a snap ring, and the extension component is correspondingly provided with an external thread part or a snap shaft; and the external nut is configured to match with the external thread part, or the snap ring is configured to match with the snap shaft.

The light post body is further formed with an assembly hole, and the assembly hole is configured to correspondingly match with the cavity outlet.

The light post body is further formed with locking pin holes, the locking pin holes are correspondingly formed in two sides of the light post body, the first component is internally formed with a shaft-passing hole, two ends of the shaft-passing hole correspondingly match with the locking pin holes, a locking pin shaft is further included, and the locking pin shaft passes through the locking pin holes and the shaft-passing hole to achieve embedded fixation of the first component and the light post body.

The conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

A first inner cavity conductive terminal in the male plug conductive component is a male plug conductive terminal, a first inner cavity conductive terminal in the female plug conductive component is a female plug conductive terminal, a first terminal jack in the male plug conductive component is a male plug part, and a first terminal jack in the female plug conductive component is a female plug part; and when the two adjacent sections of light post bodies in the light post are in butt joint, the male plug part is configured to be correspondingly in plug fit with the female plug part, so that the male plug conductive terminal is butted and matched with the female plug conductive terminal.

When there are three or more sections of light post bodies in a single light post, the light post body is divided into an end light post, a middle light post, and a tail light post, a lower end of the end light post is provided with a conductive component in a matched manner, an upper end and a lower end of the middle light post are both provided with conductive components, and an upper end of the tail light post is provided with a conductive component.

Compared with the prior art, the present invention has the following beneficial effects: according to the present invention, through optimized design of the conductive component, the conductive component can be quickly embedded and mounted in the light post body using a split plug-in structure of the first component and the second component, and an external conductive interface can be formed on the light post using the extension component, thereby facilitating conductive butt joint of other lighting components in branch rods, and avoiding routing of internal wires of the light post; under the protection of the external light post, this structure is less prone to damage, and a concentric butt-joint structure with upper and lower sections is used, which can achieve rotary blind insertion butt joint and rotary extraction of the light post without being easily damaged; and the present invention has the characteristics of a novel structure, compact fit, convenience in construction, fast and labor-saving assembly, and use of few accessories.

The characteristics of the present invention can be clearly understood with reference to the drawings and the detailed description of preferred embodiments below.

### BRIEF DESCRIPTION OF THE DRAWINGS

FIG. 1 is a schematic diagram of an overall mounting structure of a light post according to the present invention;

FIG. 2 is a schematic diagram of an overall structure of a light post in a split state according to the present invention;

FIG. 3 is a schematic diagram of an overall sectional structure of a light post according to the present invention;

FIG. 4 is a first schematic diagram of an exploded structure of a light post according to the present invention;

FIG. 5 is a second schematic diagram of an exploded structure of a light post according to the present invention;

FIG. 6 is a first schematic diagram of an exploded mounting structure of a conductive component according to the present invention;

FIG. 7 is a second schematic diagram of an exploded mounting structure of a conductive component according to the present invention;

FIG. 8 is a first schematic diagram of a sectional structure of a conductive component according to the present invention;

FIG. 9 is a second schematic diagram of a sectional structure of a conductive component according to the present invention;

FIG. 10 is a schematic diagram of a sectional structure of a first component according to the present invention;

FIG. 11 is a first schematic diagram of an assembly structure of a conductive component according to the present invention;

FIG. 12 is a second schematic diagram of an assembly structure of a conductive component according to the present invention; and

FIG. 13 is a third schematic diagram of an assembly structure of a conductive component according to the present invention.

### DESCRIPTION OF THE EMBODIMENTS

To make the technical means, creative features, objectives, and effects of the present invention easy to understand, the present invention is further described with reference to the specific drawings.

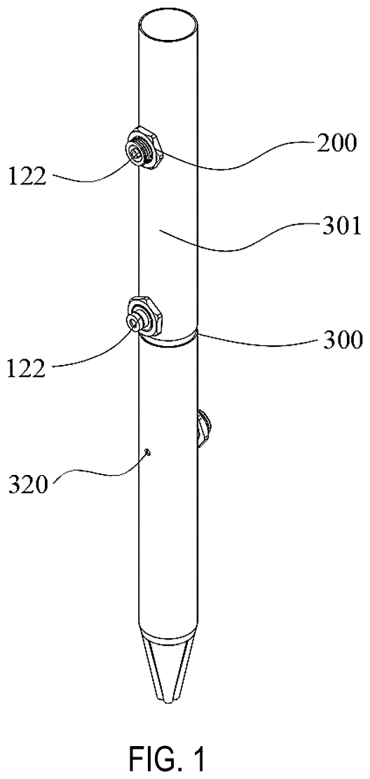

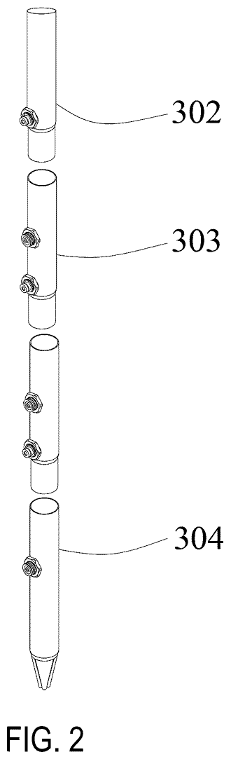

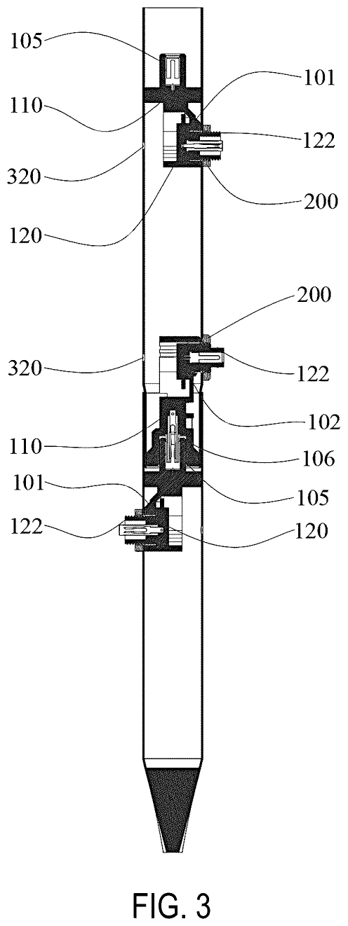

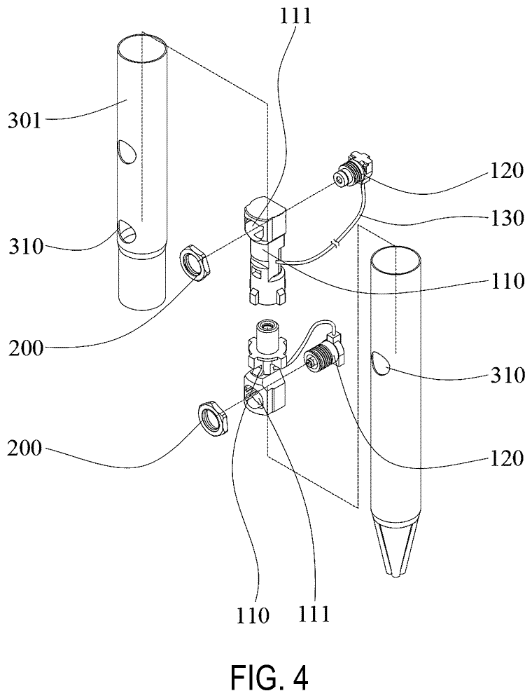

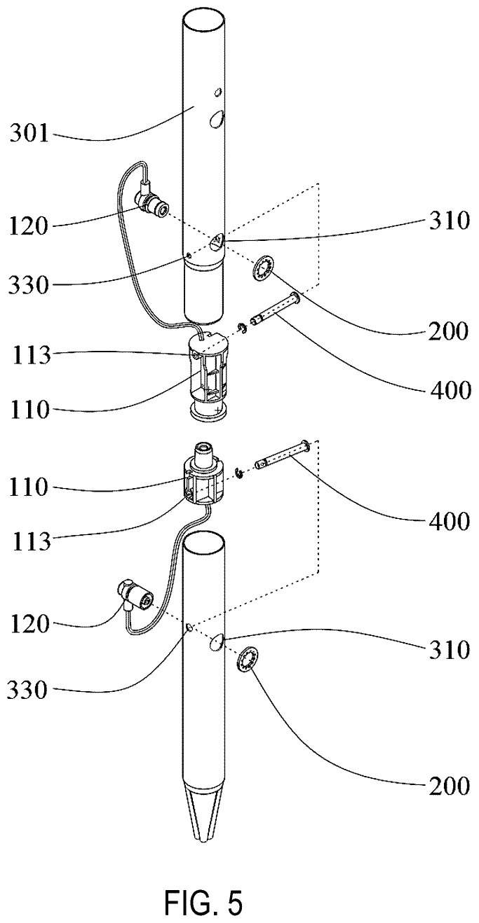

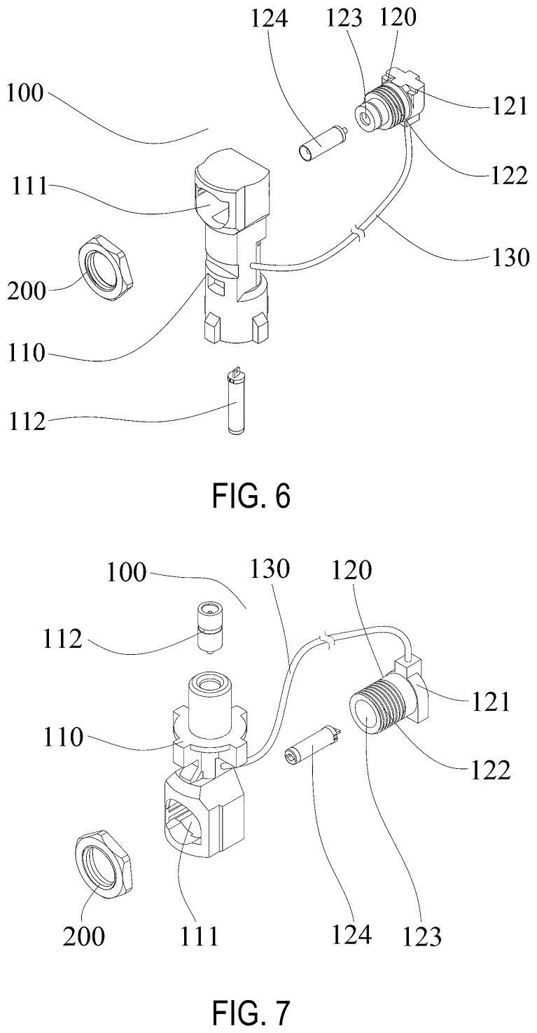

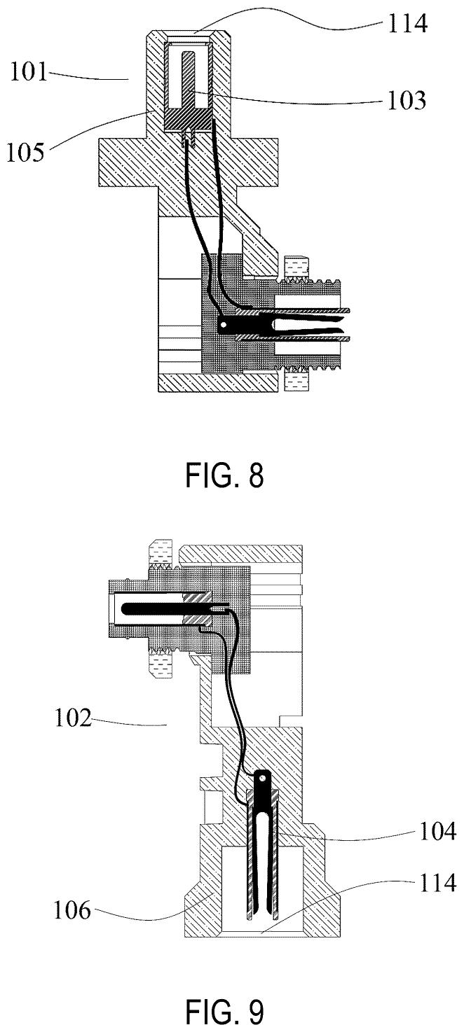

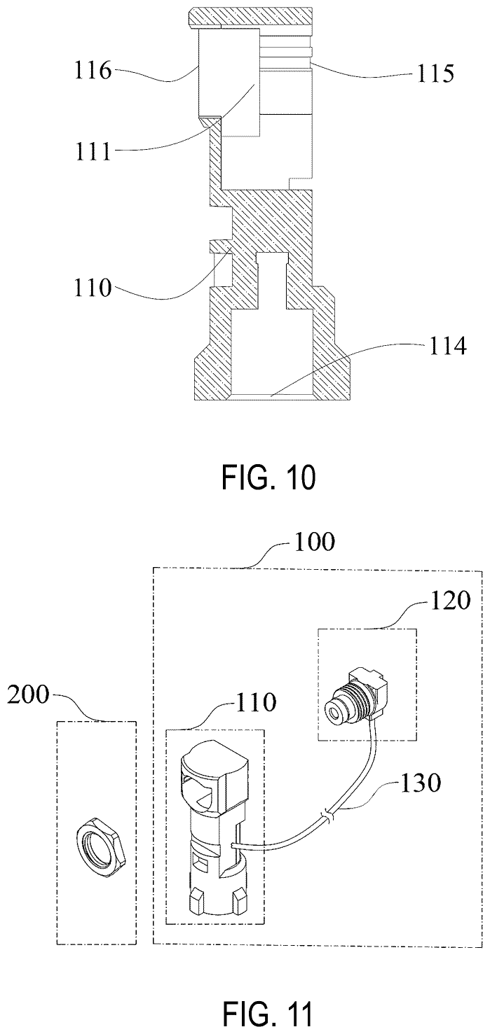

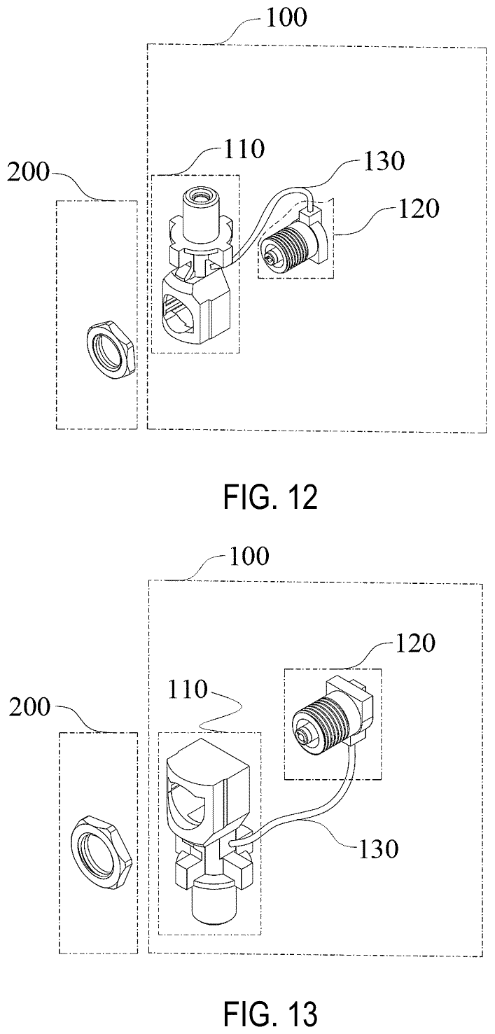

Referring to FIG. 1 to FIG. 13, this embodiment discloses a light post butt-joint conductive component structure for a decorative light, including a light post 300. The light post 300 includes at least one section of light post body 301. The light post body 301 is butted in an up-down insertion manner preferably by means of end necking. At least one end in the light post body 301 is provided with a conductive component 100 in a matched manner. The conductive component 100 includes a first component 110 and a second component 120. The first component 110 is formed with an accommodating cavity 111 for butt joint of the second component 120. Referring to FIG. 10, the accommodating cavity 111 includes a cavity inlet 115 and a cavity outlet 116. The cavity outlet 116 is configured to correspondingly match with a butt-joint hole 310 in the light post body 301. The second component 120 is accommodated in the accommodating cavity 111. Referring to FIG. 4, when the first component 110 accommodating the second component 120 is embedded and mounted in an inner cavity of the light post body 301, the second component 120 extends outward from the cavity outlet 116, partially passes through the butt-joint hole 310 to the outside of the light post body 301, and is limited and locked to the light post body 301. One part of the second component 120 is accommodated in the accommodating cavity 111, and the other part thereof is located outside the light post body 301 after passing through the cavity, thereby facilitating conductive butt joint with other external lighting components. The accommodating cavity 111 may be a cavity with an inner cavity hole or a cavity with a slide groove opening according to different specifications of structures of the second component 120.

Specifically, a locking fastener 200 is further included. The second component 120 includes a second component body 121 and an extension component 122 located at one end of the second component body 121. The second component body 121 is embedded in the accommodating cavity 111. The extension component 122 extends to an outer end of the butt-joint hole 310. The locking fastener 200 is configured to be in locking fit with the extension component 122. The first component 110 is formed with the accommodating cavity 111, so that the second component 120 can be plugged through the accommodating cavity 111. In combination with the butt-joint hole 310 in the light post body 301, the location fit among the light post body 301, the first component 110, and the second component 120 is achieved. The extension component 122 is locked in combination with the locking fastener 200, to complete fixed mounting of the components.

Preferably, the light post body 301 is further formed with an assembly hole 320, and the assembly hole 320 is configured to correspondingly match with the cavity outlet 116. After completing the assembly of the conductive component 100, the assembly hole 320 can be sealed with a plug to enhance internal sealing. In the specific assembly process, the second component 120 is fully accommodated in the accommodating cavity 111 in advance, and the first component 110 accommodating the second component 120 is correspondingly placed in the inner cavity at one end of the light post body 301. Usually, a positioning component is disposed between the light post body 301 and/or the first component 110, so that the cavity outlet 116 in the accommodating cavity 111 is accurately aligned with the butt-joint hole 310 in the light post body 301. After the cavity outlet 116 in the accommodating cavity 111 is aligned with the butt-joint hole 310, a push rod or an ejector pin is used to pass through the assembly hole 320 from the outside of the light post body 301, extend into the inner cavity of the light post body 301, and continue extending until it contacts with a sidewall of the second component 120. The push rod or the ejector pin continues extending inwards, so that the second component 120 moves outward along the accommodating cavity 111 towards the butt-joint hole 310 until the extension component 122 passes through the butt-joint hole 310. The extension component 122 is locked in combination with the locking fastener 200 to achieve fixed assembly of the conductive component 100 and the light post body 301. The assembly structure is convenient and effective, improves the efficiency of assembly between the components, and has good assembly stability. In addition, the use of fixed external components also facilitates the butt joint of other lighting components.

In the specific structure, the second component 120 further includes a second embedded conductive terminal 124, a side of the extension component 122 is formed with a second terminal jack 123, and the second embedded conductive terminal 124 is embedded and mounted in the second component 120 and correspondingly matches with the second terminal jack 123. The second embedded conductive terminal 124 in a transversal design is conveniently combined with the second terminal jack 123, which facilitates external connection of other lighting components.

The first component 110 further includes a first embedded conductive terminal 112, the first component 110 is further formed with a first terminal jack 114, the first embedded conductive terminal 112 is embedded and mounted in the first component 110 and correspondingly matches with the first terminal jack 114, and the first embedded conductive terminal 112 is conductively connected to the second embedded conductive terminal 124 by a wire 130. It is convenient to achieve the conductivity between the first embedded conductive terminal 112 and the second embedded conductive terminal 124, and it is also convenient to achieve conductive butt joint between the first component 110 and the second component 120. The first component 110 can be connected to the second component 120 by the wire 130, thereby avoiding loss of the components, and facilitating pairing.

In one preferred embodiment, the locking fastener 200 is an external nut, the extension component 122 is correspondingly provided with an external thread part, and the external nut is configured to match with the external thread part. It is convenient to achieve fixed mounting of the conductive component 100 and the light post body 301.

In one preferred embodiment, the locking fastener 200 is a snap ring, the extension component 122 is correspondingly provided with a snap shaft, and the snap ring is configured to match with the snap shaft. It is convenient to achieve fixed mounting of the conductive component 100 and the light post body 301.

In one preferred embodiment, the light post body 301 is further formed with locking pin holes 330, the locking pin holes 330 are correspondingly formed in two sides of the light post body 301, the first component 110 is internally formed with a shaft-passing hole 113, two ends of the shaft-passing hole 113 correspondingly match with the locking pin holes 330, a locking pin shaft 400 is further included, and the locking pin shaft 400 passes through the locking pin holes 330 and the shaft-passing hole 113 to achieve embedded fixation of the first component 110 and the light post body 301. The locking pin shaft 400 is added to match with the first component 110 to achieve fixed mounting of the first component 110 and the light post body 301, which can enhance the stability of mounting.

In combination with the above, the conductive component 100 is divided into a male plug conductive component 101 and a female plug conductive component 102, the male plug conductive component 101 and the female plug conductive component 102 are configured to be correspondingly mounted on the light post body 301, and two adjacent sections of light post bodies 301 in butt joint with each other in the light post 300 are butted and conductively matched with each other by the male plug conductive component 101 and the female plug conductive component 102 respectively; a first inner cavity conductive terminal 112 in the male plug conductive component 101 is a male plug conductive terminal 103, a first inner cavity conductive terminal 112 in the female plug conductive component 102 is a female plug conductive terminal 104, a first terminal jack 114 in the male plug conductive component 101 is a male plug part 105, and a first terminal jack 114 in the female plug conductive component 102 is a female plug part 106; and when the two adjacent sections of light post bodies 301 in the light post 300 are in butt joint, the male plug part 105 is configured to be correspondingly in plug fit with the female plug part 106, so that the male plug conductive terminal 103 is butted and matched with the female plug conductive terminal 104.

In one preferred embodiment, when there are three or more sections of light post bodies 301 in a single light post 300, the light post body 301 is divided into an end light post 302, a middle light post 303, and a tail light post 304. A lower end of the end light post 302 is provided with a conductive component 300 in a matched manner. An upper end and a lower end of the middle light post 303 are both provided with conductive components 300. When there are multiple sections of middle light posts 303, two adjacent middle light posts 303 are usually butted end to end. An upper end of the tail light post 304 is provided with a conductive component 300. The conductive components 300 in each light post body 301 are configured to correspondingly mount the male plug conductive component 101 and the female plug conductive component 102 respectively according to the butt-joint requirements.

According to the present invention, through optimized design of the conductive component, the conductive component can be quickly embedded and mounted in the light post body using a split plug-in structure of the first component and the second component, and an external conductive interface can be formed on the light post using the extension component, thereby facilitating conductive butt joint of other lighting components in branch rods, and avoiding routing of internal wires of the light post.

The above descriptions are only preferred embodiments of the present invention and do not limit the invention in any form. Any simple modifications, equivalent changes or modifications made to the above embodiments based on the technical principle of the present invention still fall within the scope of the technical solution of the present invention.

What is claimed is:

1. A light post butt-joint conductive component structure for a decorative light, comprising a light post, wherein the light post comprises at least one section of light post body, at least one end in the light post body is provided with a conductive component in a matched manner, wherein the conductive component comprises a first component and a second component, the first component is formed with an accommodating cavity for butt joint of the second component, the accommodating cavity comprises a cavity inlet and a cavity outlet, and the cavity outlet is configured to correspondingly match with a butt-joint hole in the light post body; and the second component is accommodated in the accommodating cavity, and when the first component accommodating the second component is embedded and mounted in an inner cavity of the light post body, the second component extends outward from the cavity outlet, partially passes through the butt-joint hole to an outside of the light post body, and is limited and locked to the light post body.

2. The light post butt-joint conductive component structure for a decorative light according to claim 1, further comprising a locking fastener, wherein the second component comprises a second component body and an extension component located at one end of the second component body, the second component body is embedded in the accommodating cavity, the extension component extends to an outer end of the butt-joint hole, and the locking fastener is configured to be in locking fit with the extension component.

3. The light post butt-joint conductive component structure for a decorative light according to claim 2, wherein the second component further comprises a second embedded conductive terminal, a side of the extension component is formed with a second terminal jack, and the second embedded conductive terminal is embedded and mounted in the second component and correspondingly matches with the second terminal jack.

4. The light post butt-joint conductive component structure for a decorative light according to claim 3, wherein the first component further comprises a first embedded conductive terminal, the first component is further formed with a first terminal jack, the first embedded conductive terminal is embedded and mounted in the first component and correspondingly matches with the first terminal jack, and the first embedded conductive terminal is conductively connected to the second embedded conductive terminal by a wire.

5. The light post butt-joint conductive component structure for a decorative light according to claim 2, wherein the locking fastener is either an external nut or a snap ring, and the extension component is correspondingly provided with an external thread part or a snap shaft; and the external nut is configured to match with the external thread part, or the snap ring is configured to match with the snap shaft.

6. The light post butt-joint conductive component structure for a decorative light according to claim 5, wherein the light post body is further formed with an assembly hole, and the assembly hole is configured to correspondingly match with the cavity outlet.

7. The light post butt-joint conductive component structure for a decorative light according to claim 1, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

8. The light post butt-joint conductive component structure for a decorative light according to claim 1, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

9. The light post butt-joint conductive component structure for a decorative light according to claim 8, wherein a first inner cavity conductive terminal in the male plug conductive component is a male plug conductive terminal, a first inner cavity conductive terminal in the female plug conductive component is a female plug conductive terminal, a first terminal jack in the male plug conductive component is a male plug part, and a first terminal jack in the female plug conductive component is a female plug part; and when the two adjacent sections of light post bodies in the light post are in butt joint, the male plug part is configured to be correspondingly in plug fit with the female plug part, so that the male plug conductive terminal is butted and matched with the female plug conductive terminal.

10. The light post butt-joint conductive component structure for a decorative light according to claim 8, wherein when there are three or more sections of light post bodies in a single light post, the light post body is divided into an end light post, a middle light post, and a tail light post, a lower end of the end light post is provided with a conductive component in a matched manner, an upper end and a lower end of the middle light post are both provided with conductive components, and an upper end of the tail light post is provided with a conductive component.

11. The light post butt-joint conductive component structure for a decorative light according to claim 2, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

12. The light post butt-joint conductive component structure for a decorative light according to claim 3, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

13. The light post butt-joint conductive component structure for a decorative light according to claim 4, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

14. The light post butt-joint conductive component structure for a decorative light according to claim 5, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

15. The light post butt-joint conductive component structure for a decorative light according to claim 6, wherein the light post body is further formed with locking pin holes, the locking pin holes are correspondingly formed in two sides of the light post body, the first component is internally formed with a shaft-passing hole, two ends of the shaft-passing hole correspondingly match with the locking pin holes, the light post butt-joint conductive component structure further comprises a locking pin shaft, and the locking pin shaft passes through the locking pin holes and the shaft-passing hole to achieve embedded fixation of the first component and the light post body.

16. The light post butt-joint conductive component structure for a decorative light according to claim 2, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

17. The light post butt-joint conductive component structure for a decorative light according to claim 3, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

18. The light post butt-joint conductive component structure for a decorative light according to claim 4, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

19. The light post butt-joint conductive component structure for a decorative light according to claim 5, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.

20. The light post butt-joint conductive component structure for a decorative light according to claim 6, wherein the conductive component is divided into a male plug conductive component and a female plug conductive component, the male plug conductive component and the female plug conductive component are configured to be correspondingly mounted on the light post body, and two adjacent sections of light post bodies in butt joint with each other in the light post are butted and conductively matched with each other by the male plug conductive component and the female plug conductive component respectively.
